(19) United States
(12) Patent Application Publication
(10) Pub. No.: US 2006/0214390 A1
(43) Pub. Date: Sep. 28, 2006

(54) Hydraulic lift trailer

(76) Inventor: Aubrey Benjamin Pinnell III, Denton, TX (US)

Correspondence Address: STORM LLP, BANK OF AMERICA PLAZA, 901 MAIN STREET, SUITE 7100, DALLAS, TX, 75202, US

(21) Appl. No.: 11/091,797

(22) Filed: Mar. 28, 2005

(51) Int. Cl. B60D 1/66

(52) U.S. Cl. 280/475

(57) ABSTRACT

An hydraulically extensible frame is coupled to the hitch portion of a trailer by a pivoting mount. The pivoting mount permits the frame to pivot between a generally vertical operative position and a generally horizontal stowed position. A foot member is secured to an end of the frame opposite the pivoting mount. The foot member engages the ground. An actuator is carried by the frame in a location adapted to be engaged by a foot of a human user when the frame is in the operative position. The actuator selectively extends the frame to raise the hitch portion in response to actuation by the foot of the user.

### BACKGROUND OF THE INVENTION

1. Field of the Invention

The present invention relates to lifting mechanism or apparatus for use with wheeled trailers for lifting a portion of the trailer. More particularly, the present invention relates to such mechanisms or apparatus for lifting a portion of the trailer associated with a hitch to facilitate coupling the hitch and trailer to another vehicle.

2. Summary of the Prior Art

Trailers, as the name implies, typically are coupled to and trail behind a towing vehicle. A ball-and-socket type trailer hitch is conventionally employed to couple the two together. The hitch is usually a forward portion of the trailer referred to as the “tongue.” Such lifts are sometimes called “tongue jacks.”

In many cases, the trailer is not coupled to the towing vehicle until the trailer is already loaded and quite heavy. The load exerted on the tongue and hitch portion of a trailer often is in excess of several hundred pounds. In such cases, attaching the trailer to the vehicle can be challenging because the hitch and tongue of the trailer generally must be raised above the level of the hitch on the vehicle, the two portions of the hitch aligned, and the tongue portion of the trailer lowered to fully engage the hitch. Accordingly, various lifting mechanisms have been associated with such trailers to facilitate the coupling operation. The lifting mechanism also supports the tongue and hitch (or forward) end of the trailer when it is uncoupled from the towing vehicle.

Improvements have been made over time to the lifting mechanisms or apparatus used in conjunction with trailers. Such improvements include the use of electric motors and hydraulics to raise and lower the tongue and hitch of the trailer. Hydraulic lifts are smoother and often safer in operation than mechanical lifts, which can be subject to backlash. U.S. Pat. No. 3,273,858 to Coburn discloses a hand-operated hydraulic elevator for a trailer tongue. U.S. Pat. No. 4,911,460 to DePaula discloses a hand-operated mechanical arrangement. U.S. Pat. No. 5,011,119 to Harrington discloses another hand-operated hydraulic jack.

A typical consumer use for a trailer is to haul a boat. In such applications, the trailer often is partially submerged in water when loading and unloading the boat. Use in or near water militates against the use of electrically actuated systems. Even without the presence of water, electrically operated systems require a connection to an electric power source (usually that of the towing vehicle) and present complications and reliability concerns. Hand-pumped hydraulic or hand-cranked mechanical systems avoid these shortcomings, but require the use of at least one of the operator's hands, which leaves only one (if any) hand free to manipulate the hitch or perform other operations. Moreover, the level of the lift and trailer tongue is usually low enough to the ground to make hand operation awkward and possibly unsafe.

A need exists, therefore, for a lift mechanism or apparatus for a wheeled trailer that has simple, reliable construction and that is safe, easy, and convenient to use.

### SUMMARY OF THE INVENTION

It is a general object of the present invention to provide an improved lift for a wheeled trailer to be towed behind a vehicle. This and other objects of the invention are attained by providing an hydraulically extensible frame that is coupled to the hitch portion of the trailer by a pivoting mount. The pivoting mount permits the frame to pivot between a generally vertical operative position and a generally horizontal stowed position. A foot member is secured to an end of the frame opposite the pivoting mount. The foot member engages the ground. An actuator is carried by the frame in a location adapted to be engaged by a foot of a human user when the frame is in the operative position. The actuator selectively extends the frame to raise the hitch portion in response to actuation by the foot of the user.

According to the preferred embodiment of the present invention, the frame further comprises a bottle jack having a cylinder and a rod, the rod being selectively extensible from an end of the cylinder responsive to actuation from the actuator.

According to the preferred embodiment of the present invention, a tubular member carried concentrically and in sliding relation about the cylinder of the bottle jack, the tubular member being secured to and movable with the rod.

According to the preferred embodiment of the present invention, the actuator further includes a biasing member to maintain the actuator in an operative position.

According to the preferred embodiment of the present invention, the actuator comprises an actuator hydraulic cylinder in fluid communication with the hydraulic cylinder, the actuator cylinder including an actuator rod.

According to the preferred embodiment of the present invention, a foot pedal is operatively coupled to the actuator rod, the foot pedal being biased in an upward position by the biasing member.

According to the preferred embodiment of the present invention, the wheeled trailer is adapted to carry a boat.

Other objects, features, and advantages of the present invention will become apparent with reference to the drawings and detailed description, which follows.

### BRIEF DESCRIPTION OF THE DRAWINGS

FIG. 1 is an elevation view of a wheeled trailer including the lifting apparatus according to the present invention.

FIG. 2 is an enlarged elevation view of the lifting apparatus of FIG. 1 in a deployed or near-vertical position.

FIG. 3 is an elevation view of the lifting apparatus of FIGS. 1 and 2 pivoted into a stowed or near-horizontal position.

FIGS. 4 and 5 are an enlarged elevation view, partially in section, of the lifting apparatus of FIGS. 1, 2, and 3.

FIG. 6 is an enlarged, fragmentary view, partially in section, of the attachment or mounting of a portion of lifting apparatus according to the present invention to a portion of the trailer.

### DETAILED DESCRIPTION

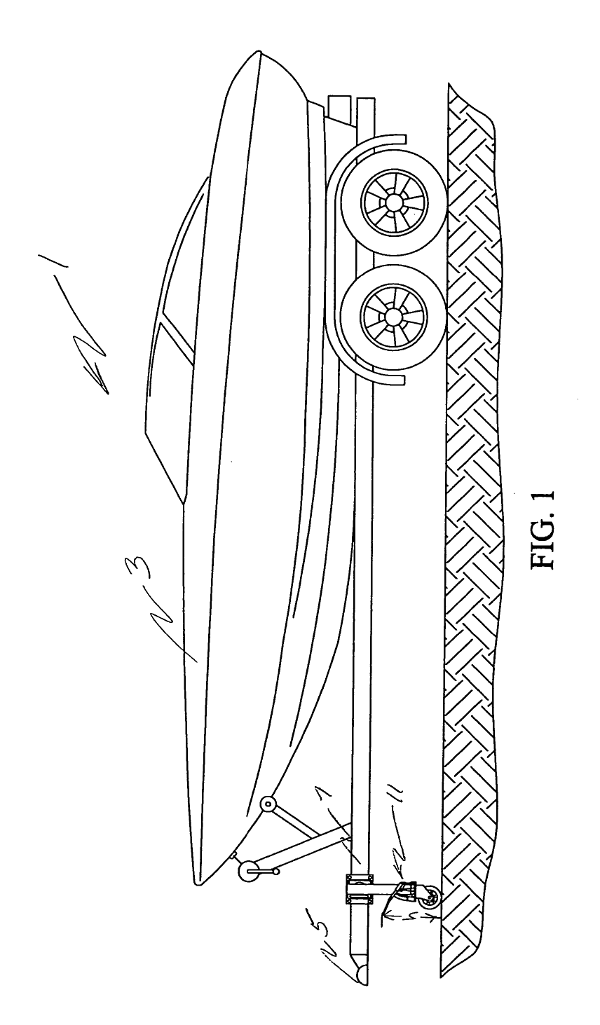

Referring now to the Figures and particularly to FIG. 1, the numeral 1 designates a wheeled trailer of the type with which the present invention is employed. The present invention is particularly adapted to those wheeled trailers that are adapted to haul or carry boats 3, such as that illustrated in FIG. 1, because of the relatively great loaded weight of such trailers and the frequency with which they are coupled and uncoupled from a towing vehicle. As can be seen, trailer 1 has a hitch 5 at a forward portion thereof, which is secured to a tongue portion 7 of trailer 1. Typically, hitch 5 is a socket member that registers with a corresponding hitch ball (not shown) on a towing vehicle (also not shown).

A lifting mechanism or apparatus (“lift”) 11 according to the present invention is secured to a tongue portion 7 of trailer proximal to or near hitch 5. As shown in FIG. 1, lift 11 serves as a third wheel or support to maintain trailer 1 in a generally level orientation when trailer 1 is not coupled to a towing vehicle. A lift 11 according to the present invention finds particular utility in those trailers 1 adapted to carry or haul boats because such trailers often are extremely heavy and incapable of being manipulated solely by a user, without the assistance of a mechanical advantage.

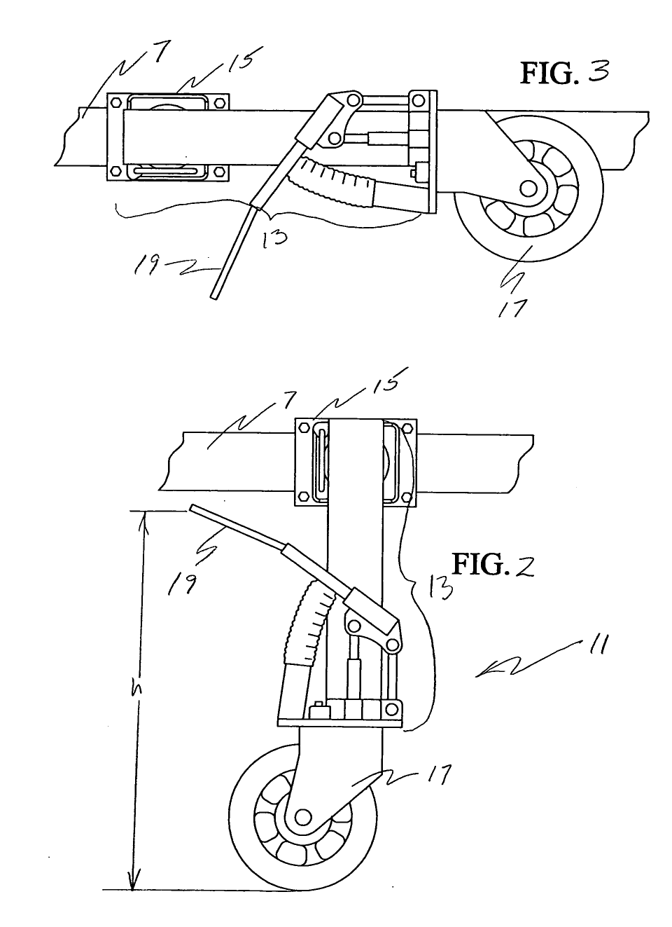

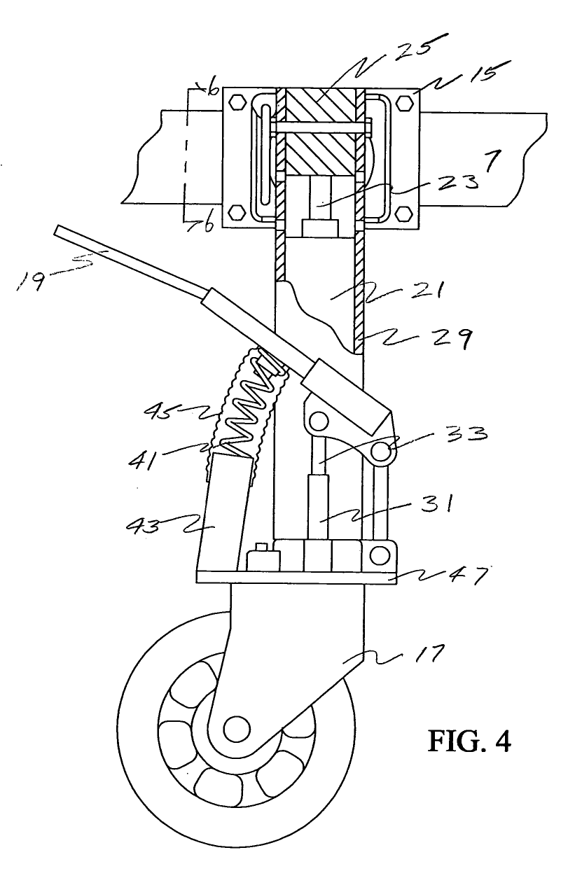

FIGS. 2 and 3 are enlarged elevation views of the lift 11 according to the present invention illustrating the lift in a deployed or near-vertical position (FIG. 2) and a stowed or near-horizontal position (FIG. 3). Lift 11 generally comprises a hydraulically extensible frame 13 that is coupled to a generally horizontally extending portion of trailer tongue 7 by a pivoting mount or bracket 15. At its lower end, frame 13 terminates in a foot member, which is preferably a wheel but may be another type of support. Additionally, frame 13 (and lift 11) is provided with an actuator 19 in the form of a foot pedal. Foot pedal 19 is arranged to be no higher than a selected height h of about 18-24 inches so that it is adapted to be engaged and operated by a foot of a human user.

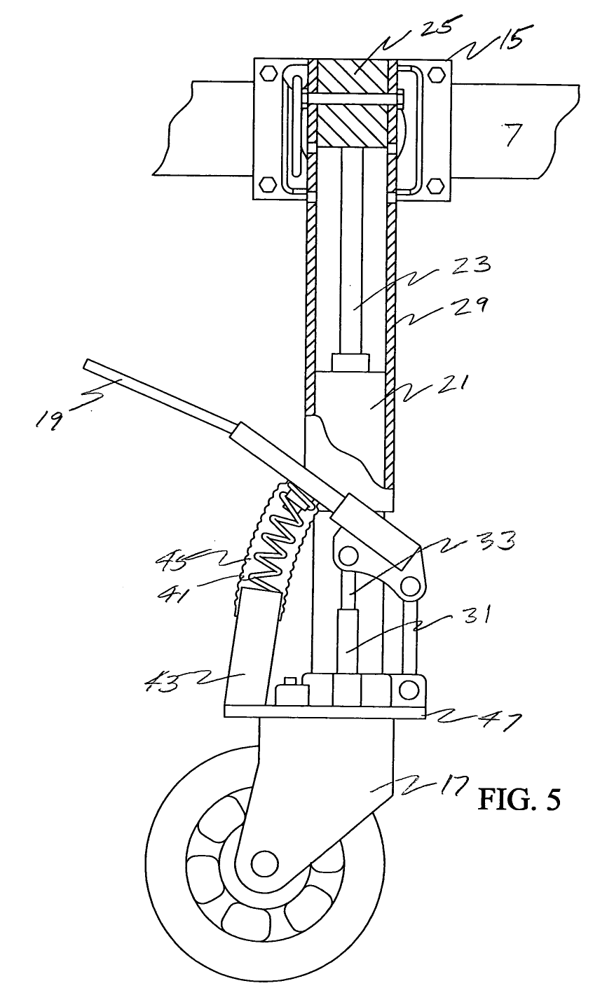

FIGS. 4 and 5 are enlarged elevation views, partially in section, of lift 11 according to the present invention. FIG. 4 depicts lift 11 in a retracted or fully compressed stated while FIG. 5 depicts lift 11 in an extended state in which tongue 7 of trailer 1 is being (or has been) raised by lift 11. The hydraulically extensible frame (13 in FIG. 2) of lift 11 comprises a conventional bottle jack, which has an hydraulic cylinder 21 and a rod 23 extending or protruding a selected and variable distance from cylinder 21. According to the preferred embodiment of the present invention, the bottle jack is commercially available, such as the AC-Delco® Hydraulic Bottle Jack, Model 34112.

Rod 23 terminates at its end in a cylindrical member 25, which preferably is a steel cylinder welded to the end of rod 23. Rod 23 preferably has a threaded exterior and its protrusion from cylinder 21 is adjustable by rotating rod 23 relative to cylinder 21. This provides an adjustment of the overall height of frame 13 to accommodate towing vehicles with differing bumper (and hitch) heights. A conventional bolt 27 extends through cylindrical member 25 to couple a tubular frame member 29 to rod 23. Rod 23 is the portion of the bottle jack that extends upwardly from cylinder 21 responsive to hydraulic actuation of the bottle jack. Tubular frame member 29 thus moves up and down with rod 23 relative to cylinder 21. Tubular frame member 29 is dimensioned to slide concentrically over and cover cylinder 21. In the fully compressed position depicted in FIG. 4, cylinder 21 of the bottle jack is almost completely covered by frame member 29.

Foot pedal or actuator 19 is coupled to an actuator cylinder 31 and actuator rod 33. Actuator rod and cylinder 31, 33 are part of the bottle jack and operate to exert pressure on the hydraulic fluid in cylinder 21 of the bottle jack, thereby extending rod 23 from cylinder 21 and raising or extending the frame of lift 11, in turn raising tongue 7 of trailer 1. As noted previously, actuator pedal 19 is designed, intended, and adapted to be operated by the foot of a human user. Accordingly, it is preferably no higher than a height h of about 18 inches from the ground when lift 11 is in the deployed position. Height h should not exceed 24 inches if an average human operator is to use lift 11 without risking the loss of balance.

In addition to being positioned to be engaged by a foot, foot pedal or actuator 19 is biased into an upward position by a compression coil spring or biasing member 41. Spring 41 maintains pedal 19 in the upward position at all times (except when pedal 19 is depressed by an operator) and permits the operator's foot to do actuation work only on the downward stroke of pedal 1. Spring 41 is captured between pedal 19 and base plate 47 of the bottle jack by a tube 43. The upper extent of spring 41 is covered with a plastic or metallic bellows 45 for aesthetic and functional purposes (to improve appearance and to keep materials from being pinched or caught in spring 41).

A stopcock 37 functions to release pressure within the bottle jack, thereby permitting rod 23 and tubular frame 29 to compress or retract relative to bottle jack cylinder 21, in turn lowering tongue 7 of trailer 1.

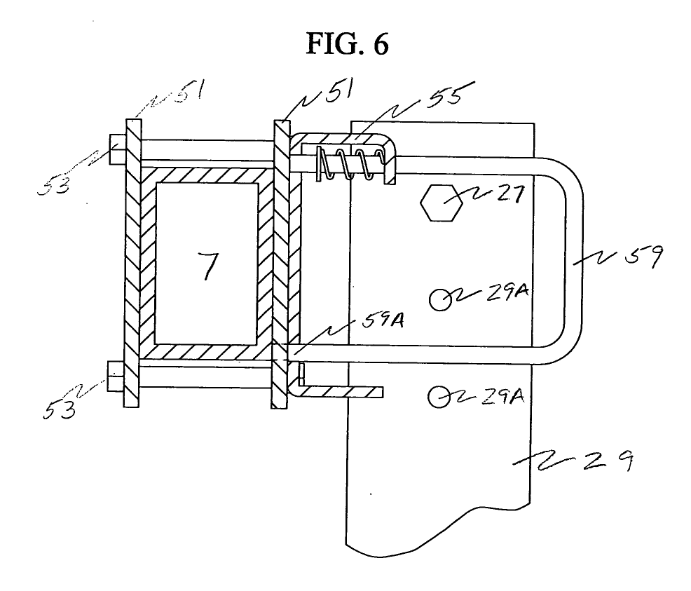

FIG. 6 is an elevation view, partially in section, of pivoting mount 15, taken along the section line 6-6 of FIG. 5. Mount 15 comprises a pair of parallel, spaced-apart plates 51 that are secured to either side of the box-girder of trailer tongue 7 by four bolts 53, two of which are shown in FIG. 6. A bracket 55 is mounted for rotation on one of plates 51 by a pivot or axle 57. Bracket 55 is, in turn, welded to tubular frame member 29.

A U-shaped, spring-loaded handle 59 is secured to bracket 55. One end 59A of handle 59 extends through an aperture in bracket 55 and into an aperture in plate 51, thereby securing bracket 55 and tubular frame member 29 of lift 11 against rotation relative to trailer tongue 7. By pulling outward (to the right in FIG. 6) on handle 59, end 59A is disengaged from the aperture in plate 51, freeing bracket 55, frame 29 and lift 11 to pivot between the stowed and deployed positions illustrated in FIGS. 2 and 3.

FIG. 6 also illustrates a fixed height adjustment provided for lift 11 by holes or apertures 29A formed in the wall of tubular frame member 29. By removing bolt 27, moving frame member 29 relative to cylindrical member (25 in FIGS. 4 and 5) into alignment with one of the other apertures 29A, and re-inserting bolt 27, the overall height of lift 11 can be adjusted in a fixed fashion, without regard to the level of extension of rod (23 in FIGS. 4 and 5) relative to cylinder (21 in FIGS. 4 and 5) or tubular member 29.

In operation, lift 11 is coupled to tongue 7 of trailer near hitch 5 as shown in FIGS. 1 and 6. Frame 13 of lift 11 is pivoted to the deployed or near-vertical position as shown in FIG. 2. Lift then is capable of supporting the forward or front end of trailer 1, even under load. To couple hitch to a towing vehicle, foot pedal 19 is actuated by an operator's foot, extending rod 23 from cylinder 21 and extending tubular frame 29 relative to foot member 17, thereby raising tongue 7 relative to the ground. Tongue 7 and hitch 5 may then be aligned, with the assistance of wheeled foot member 17, over the hitch ball. Stopcock 37 is then released to permit rod 23 to retract into cylinder 21 and frame member 29 to retract relative to foot member 17. Tongue 7 and hitch 5 then are lowered into engagement with the hitch ball. The process is essentially reversed to disengage or uncouple trailer 1 from the towing vehicle. Additionally, by manipulating handle 59 of mount 15, lift 11 may be pivoted between stowed and deployed positions to facilitate towing trailer 1 over uneven terrain.

The lift according to the present invention has a number of advantages. It is hydraulic, so it is smooth in operation and avoids the potentially dangerous “kickback” and backlash sometimes encountered in purely mechanical systems. It is not electrically operated, making it safe and reliable even in marine environments. It is operated by the foot and leg muscles of the operator, which are stronger than hand and arm muscles. Further, foot operation or actuation permits the operator to keep his or her head or face away from trailer and hitch components for safety in the event of failure. The lift according to the present invention is simple in construction and operation, making manufacturing, repair, and replacement inexpensive.

The invention has been described with reference to a preferred embodiment thereof. It is thus not limited, but is susceptible to variation and modification without departing from the scope of the invention.

I claim:

1. A lift for a wheeled trailer adapted to be coupled to a vehicle by a hitch, the lift comprising:
a frame having a foot member at one end, the foot being adapted to engage a ground surface;
a mount secured to the frame at an end opposite the foot member, the mount for securing the frame to the trailer at a location proximal to the hitch;
an hydraulic cylinder associated with the frame for raising and lowering at least the hitch portion of the trailer relative to the ground surface;
an actuator coupled to the hydraulic cylinder for selectively actuating the cylinder to raise and lower the hitch portion of the trailer, the actuator being positioned and adapted to be engaged and operated by a foot of a human operator.

2. The lift according to claim 1, wherein the foot member includes a wheel adapted to roll on the ground surface.

3. The lift according to claim 1, wherein the hydraulic cylinder forms a portion of the frame.

4. The lift according to claim 1, wherein the mount permits the frame to pivot from a deployed position in which the frame is generally perpendicular to the hitch portion and ground surface and a stowed position in which the frame is generally parallel to the hitch portion and ground surface.

5. The lift according to claim 1, wherein the actuator further includes a biasing member to maintain the actuator in an operative position.

6. The lift according to claim 1, wherein the hydraulic cylinder further comprises a rod extending from the cylinder, the rod selectively extending from the cylinder in response to manipulation of the actuator by the foot of the user.

7. The lift according to claim 6, wherein the foot member is coupled to a lower end of the hydraulic cylinder, a tubular member is coupled to the rod at an upper end of the hydraulic cylinder, and the mount is coupled to the tubular member.

8. The lift according to claim 1, wherein the actuator comprises:
an actuator cylinder in fluid communication with the hydraulic cylinder, the actuator cylinder including an actuator rod; and
a foot pedal operatively coupled to the actuator rod, the foot pedal being biased in an upward position by a biasing member.

9. The lift according to claim 1, wherein the wheeled trailer is adapted to carry a boat.

10. A lift for the hitch portion of a wheeled trailer, the lift comprising:
a bottle jack having a cylinder and a rod, the rod being selectively extensible from an end of the cylinder responsive to actuation;
a tubular member carried concentrically and in sliding relation about the cylinder of the bottle jack, the tubular member being secured to and movable with the rod;
a pivoting mount securing the tubular member to the hitch portion of the trailer, the pivoting mount permitting the tubular member and bottle jack to pivot between a deployed position in which the bottle jack and tubular member extend generally perpendicular to the ground surface, and a stowed position in which the bottle jack and tubular member are generally parallel to a ground surface;
a foot member secured to an end of the bottle jack opposite that from which the rod extends, the foot member adapted to engage the ground surface and support a portion of the trailer when the bottle jack and tubular member are in the deployed position.

11. The lift according to claim 10, wherein the foot member includes a wheel adapted to roll on the ground surface.

12. The lift according to claim 10, further comprising an actuator for the bottle jack, the actuator being positioned and adapted to be engaged and operated by a foot of a human operator when the bottle jack is in the deployed position.

13. The lift according to claim 12, wherein the actuator further includes a biasing member to maintain the actuator in an operative position.

14. The lift according to claim 12, wherein the actuator comprises:
an actuator hydraulic cylinder in fluid communication with the bottle jack cylinder, the actuator cylinder including an actuator rod;
a foot pedal operatively coupled to the actuator rod, the foot pedal being biased in an upward position by a biasing member.

15. The lift according to claim 10, wherein the wheeled trailer is adapted to carry a boat.

16. A lift for selectively raising and lowering a hitch portion of a wheeled trailer, the lift comprising:
an hydraulically extensible frame;
a pivoting mount coupling an end of the frame to the hitch portion of the wheeled trailer, the pivoting mount permitting the frame to pivot between a generally vertical operative position and a generally horizontal stowed position;
a wheel secured to an end of the frame opposite the pivoting mount; and
an actuator carried by the frame in a location adapted to be engaged by a foot of a human user when the frame is in the operative position, the actuator selectively extending the frame to raise the hitch portion in response to actuation by the foot of the user.

17. The lift according to claim 16, wherein the frame further comprises:
a bottle jack having a cylinder and a rod, the rod being selectively extensible from an end of the cylinder responsive to actuation from the actuator; and
a tubular member carried concentrically and in sliding relation about the cylinder of the bottle jack, the tubular member being secured to and movable with the rod.

18. The lift according to claim 16, wherein the actuator further includes a biasing member to maintain the actuator in an operative position.

19. The lift according to claim 17, wherein the actuator comprises:
an actuator hydraulic cylinder in fluid communication with the bottle jack cylinder, the actuator cylinder including an actuator rod;
a foot pedal operatively coupled to the actuator rod, the foot pedal being biased in an upward position by the biasing member.

20. The lift according to claim 16, wherein the wheeled trailer is adapted to carry a boat.
